(19) United States
(12) Patent Application Publication
(10) Pub. No.: US 2015/0323435 A1
(43) Pub. Date: Nov. 12, 2015

(54) Containment integrity sensor device

(71) Applicants: Steven Slupsky, Edmonton (CA); Christopher Sellathamby, Edmonton (CA)

(72) Inventors: Steven Slupsky, Edmonton (CA); Christopher Sellathamby, Edmonton (CA)

(21) Appl. No.: 14/710,559

(22) Filed: May 12, 2015

Related U.S. Application Data
(60) Provisional application No. 61/992,077, filed on May 12, 2014.

(51) Int. Cl. G01N 3/08; G01M 99/00

(52) U.S. Cl. CPC G01N 3/08; G01M 99/007

(57) ABSTRACT

A containment integrity sensor device has a force sensor integrally formed within an elastic compressible material, the elastic compressible material having a first surface and a second surface opposite the first surface. The force sensor generates a signal in response to a compressive force applied to the first and second surfaces, the signal being indicative of the compressive force.

### FIELD

This relates to a containment integrity sensor device, which may be referred to as a gasket sensor, a wear sensor or a combination thereof herein. In particular, the wear sensor may be a compressible elastic displacement sensor or wear sensor, to be attached to a component of equipment or a structure for determining status and sensing one or more changes occurring at that component, such as alignment, gap, unloading, creep, wear, disintegration and failure. The sensor is sealed so that it may be operated in either hazardous or non-hazardous environments and is compatible with liquids, temperature, vibration and other environmental conditions.

### BACKGROUND

Sensors are used to determine and monitor status and conditions of equipment and the environment at that equipment. For example, a sensor may be used to monitor temperature, humidity, atmosphere at an environment or other ambient conditions. Other sensors are used to monitor physical parameters of equipment, and the status of the equipment itself, including determining strain, vibration, and development of cracking.

Sensors also may be used to log data. Powers et al. in U.S. Pat. No. 5,381,136 (1995) describe a remote logger unit for monitoring a variety of operating parameters along a fluids distribution or transmission system. An RF link is activated by which a logger unit alerts a central controller when predetermined operating limits are exceeded. Farther logger units transmit data via closer logger units in daisy chain fashion.

Arms in U.S. Pat. No. 6,588,282 (2003) describes peak strain linear displacement sensor for monitoring strain in structures. The device records data and can report strain history for the structure to which it is attached. A displacement sensor is constrained so that it shows maximum movement in one direction resulting in deformation of the structure to which it is attached.

Hamel et al. in U.S. Pat. No. 7,081,693 (2006) and U.S. Pat. No. 7,170,201 (2007) describe devices for powering a load by harvesting energy as electrical energy from an ambient source, storing said electrical energy, and switching the storage device to provide electrical energy when required to a load such as a sensor. The example is provided of powering a sensor for monitoring tire pressure and transmitting that data.

Arms et al. in U.S. Pat. No. 7,696,621 (2010) and in a conference presentation, “Wireless Strain Sensing Networks,” 2nd European Workshop on Structural Health Monitoring, Munich, Germany, Jul. 7-9, 2004, describe a RFID tag packaging system for an electronic device located within a cavity in an adjacent flexible material. The dimensions of the flexible material are chosen so as to provide protection of the electronic device from loading applied to the device.

Bennett in U.S. Pat. No. 8,061,211 describes a seal with integrated sensor. This approach provides a seal member having both sealing and sensing functionality that is capable of sealing and determining if the seal is under proper compression or torque load. Moreover, the sealing material is preferably two concentric O-rings made of a dielectric material of low conductivity with electrically conducted or chemically reactive particulates within. Since liquid or gas seals are made of a variety of materials and have a multitude of design configurations that include, but are not limited to, (i) a circular conformable elastomer O-ring seated in a channel (gland) of a metallic or plastic fitting, (ii) circular washer made of soft conformable metallic or plastic material, (iii) flat gasket of various flat patterns made with conformable fibrous, cellulous, particulate, or polymeric material, (iv) circular compression fittings with offset tapered mating surfaces, (v) circular flared fittings with conformable flared tubings, and (vi) circular threaded pipe fittings with offset tapers, etc., an O-ring being only one of a multitude of design configurations, it is desirable to have a sensor configuration that is independent of the gasket configuration and material.

Another aspect of Bennett involves errors in the measurement of the compression or torque load that arise due to a non-uniform sealing material. A non-uniform material can arise due to non-uniform density of conductive particles within the seal material and due to a non-uniform thickness of the seal material. The magnitude of these errors is compounded and proportional to the area of the seal and so is of particular concern where the area of the seal is large as can be found in large diameter hydrocarbon transport pipelines that can be 12″, 18″, 24″, 30″, 36″, 48″ or larger in diameter.

U.S. Pat Application No. 2012/0043980 to Davis discloses a wear sensor comprises an electric circuit supported on a substrate. The circuit is electrically connected with a measuring device. As the sensor wears, the elements are sequentially decoupled from the circuit thereby changing the characteristic measured by the device. In another embodiment, as wear progresses, the conductors are progressively worn away thereby electrically decoupling the elements from the circuit although the elements themselves are never subjected to wear. Davis also discloses the communication lead could be connected to a wireless communication device.

European Pat No. EP0616144A1 to Klaus-Dieter et al. discloses a multi-stage wear sensor, in particular for brake pads.

U.S. Pat. No. 7,677,079 to Radziszewski et al. discloses a sensor for detecting erosion of a wear surface of a component, particularly a liner attached to the mill shell of a rotating grinding mill.

U.S. Pat. No. 7,270,890 to Sabol et al., discloses a system for monitoring the wear of a component. The component can include a base material which can be any of a number of materials including, for example, metals, ceramics, ceramic matrix composites, plastics, composites. The wear conductors may or may not be insulated from the surrounding environment. For instance, when the base material or the coating is an electrically insulating material and the wear conductors 20 are embedded therein.

A preferred approach to maintenance is “Condition-Based Maintenance” (“CBM”) or “Reliability Centered Maintenance” (“RCM”). Equipment downtime, both scheduled and unscheduled, is an important factor of production loss. In addition, according to a study by Optimal Maintenance Decisions Inc. (OMDEC), a leader in RCM management solutions, failures in the field are three times more costly to repair (considering overtime, rescue, and expedited shipping of parts) than scheduled (or preventive) maintenance operations.

Hence, CBM is replacing preventive maintenance in many industrial operations as a result of gains in productivity. CBM is a maintenance system prevalent in civil infrastructure, industrial mining and energy operations. CBM monitors industrial equipment, civil structures and their constituent components (collectively referred herein as “assets”) to establish an optimal maintenance cycle (based on the predictions of when a machine will fail using strain and vibration measurements, for example).

While preventive maintenance repairs machinery, civil structures and their constituent components every given time period, even if the asset is still operational, CBM can extend that time period. The optimal maintenance cycle determines the best time to shut down an asset for preventive repair. Finding the balance between repairing often and continuing to produce is often difficult.

As an example, strain and fatigue measurements reveal risks of yield failures and cracking, changes in material properties, and remaining equipment life, making them incredibly useful for CBM if monitored.

In the infrastructure, mining and energy industries, strain and vibration are not generally monitored by built-in systems, mainly due to the complexity of sensor installation and computational intensity of the data processing. CBM relies heavily on regular or continuous measurements of parameters that allow operators to determine when the asset will fail (i.e. strain and vibration).

Electronic sensors measure physical quantities (such as strain, temperature, acceleration, crack propagation, pressure, displacement, force, etc.) and convert them into signals read by an instrument (the reader varies depending on the type of sensor).

For example, strain gauges consist of a foil pattern (often in a tight zigzag) insulated in a flexible material and attached to an object under strain. As the object deforms, the resistance of the foil wires changes, allowing a Wheatstone bridge circuit (a measuring instrument used to measure an unknown electrical resistance) to record the variations.

In the energy, manufacturing and civil infrastructure industries flanges are commonly used to connect two separate components, such as spools of pipe, where a seal needs to be maintained between the components to contain a liquid or gas within the components. Such connections typically use a gasket that is compressed between the two flanges to provide a seal and prevent LOC. Thermal cycles, vibration, shock, fatigue, normal force and other mechanical influences cause the gaskets to loose their seal resulting in LOC.

It is known that sealing using conformable materials is achieved when such material is placed between relatively rigid mating surfaces and that sealing occurs when the material is put under pressure and displaces to conform to and fill the space between the mating surfaces.

It is also known that sealing of relatively rigid mating surfaces is achieved when such surfaces are in full or partial and often tight contact. Examples of such sealing are compression fittings and threaded pipe fittings that often have tapered mating surfaces that are offset to create tight contact during rotational tightening.

Unfortunately, existing CBM solutions have been historically inaccurate, are expensive or non-viable, and/or produce poor signal transmission and short battery life.

CBM's reliance on high data volume dictates a need to monitor continuously (or at least often) strain and loading. To understand fully an assets state requires monitoring of stress, accumulated stress, fatigue cycles, cracks and crack growth. However, monitoring the hundreds of assets used every day in a civil and industrial operations requires many sensors and many more wires, which are difficult and expensive to install and maintain. Moreover, the data requirements for continuous monitoring are large leading to large storage requirements and power consumption which negatively effects size and lifetime of the systems used to collect the data.

Many solutions have not reliably predicted when a machine or component will fail. This parameter is probably the most important when it comes to CBM, since CBM relies on accurate predictions of failure. The inability to predict correctly when an asset will fail can have grave consequences on unplanned downtime as well as operator safety.

Some solutions offer accurate predictions, but at high costs, whether in the stages of installation and setup, longevity and data collection, or analysis and data post-processing.

Yet other solutions offer poor signal transmission due to low range or lack of direct line of sight. Power supplies dictate operating conditions and longevity of the solution. Most solutions require too much power to operate for long periods of time, or are too delicate to operate in the harsh conditions of mining operations. Conditions can include extreme temperatures, constant vibration, and quick acceleration.

Accordingly, what is needed is a discrete sensor, separate from the seal or gasket, may be compatible with a multitude of seal configurations, may be constructed of different materials than those used to form the seal, and the performance of which is not affected by the size of the seal, that is capable of determining if the seal is under proper compression or torque load, and that is also capable of sensing contained fluid pressure and pressure variation indicating leakage across the sealing member. Further, what is needed is a sensor to detect when the compression of a gasket becomes compromised and a method to continuously monitor the integrity of the gasket and communicate this information so as to notify maintenance or other appropriate personnel to the condition of the seal. Moreover, a sensor that can provide an accurate indication of the gap between or displacement of a flange, provide for a gasket with its thickness minimally increased due to the sensor, provide an ability to route the sensor wiring about passages extending outside the flange, have separately replaceable components in service, and be provided in an economical fashion, both in manufacture and in use.

Moreover, it would be advantageous to be able to determine the pressure that the seal is under, and in particular, to determine any pressure variance around the course of the seal. This could be used to determine if the seal member is unseated, seated properly and evenly, and tightened under the appropriate compression or torque. In addition, it would be advantageous to be able to sense the contained fluid pressure being exerted onto the seal to ascertain if a leak path has been initiated there through.

Other seal sensors function by measuring pressure. Moreover, most pressure sensors, however, function by converting mechanical movement of a diaphragm to an electrical change in resistance or capacitance. This is achieved through the use of active materials like piezo film. However, such sensors are fairly costly, and in addition, it would be difficult to use such sensors to determine if a seal is under uniform pressure and seated properly.

Furthermore, other sensors function by measuring a relative difference in pressure between more than one sensor arranged circularly around the sealing surface and are not calibrated to measure the pressure or force accurately and do not measure displacement. Thus it would be difficult to use such sensors to quantitatively determine pressure or to measure the displacement between the sealing surfaces.

Other sensors are limited to a thickness that is the same as the sealing material. It would be difficult to use such sensors to align the sealing surfaces before assembly and compression or torque load due to there being compression on the seal during alignment procedures.

Accordingly, it would be advantageous to have a sensor that can measure the force and displacement at a location and is calibrated to provide a quantitative measurement of pressure, force or displacement or any combination thereof. Moreover, it would be advantageous to measure alignment of the sealing surfaces before the seal is compressed.

Loss of containment can also be the result of wear in the material providing the seal. Accordingly, it would be advantageous to have a sensor that can measure the wear of the material providing the containment.

### SUMMARY

According to an aspect, there is provided a discrete gasket sensor device, comprising a force sensor integrally formed within an elastic compressible material, the elastic compressible material translates displacement a first surface relative to a second surface into a force where the force sensor generates an electrical signal that is proportional to the displacement of the elastic compressible material. The sensor may be constructed of the same or similar material as the seal or gasket. Alternatively, the sensor may be constructed of a different material as the seal or gasket to alter or improve the sensitivity and other characteristics of the sensor. Preferably such sensor is separate and distinct from the seal or gasket and is compatible with a multitude of seal configurations and materials. Preferably, at least one or more of the sensors may be positioned along a circular path inside and parallel to the outer perimeter of the flange surface. Preferably, the performance of the sensor is not affected by the size of the seal or gasket and is capable of determining if the seal is under proper compression or torque load.

Another embodiment of the sensor involves sensing contained fluid pressure and pressure variation indicating leakage across the sealing member. Moreover, the sensor can provide an accurate indication of the gap or displacement between two opposing surfaces of a flange.

Preferably, the sensor is provided so that a seal or gasket thickness is not increased due to the size of the sensor. Alternatively, the seal or gasket is minimally increased due to the size of the sensor.

Preferably there is provided an ability to route the sensor wiring about passages extending outside the flange, have separately replaceable components in service, and be provided in an economical fashion, both in manufacture and in use.

There is provided a method to continuously monitor the integrity of the gasket involves measuring the signal from the sensor, calculating the compression or torque load or displacement and recording this data. The data may be communicated to another location in the immediate vicinity or to a remote location using wireless techniques described herein so as to notify maintenance or other appropriate personnel to the condition of the seal or gasket or the condition of the alignment of the flange before or during compression of the seal or gasket.

The sensor may include a force sensor and temperature sensor to provide temperature compensation to the force sensor. In another aspect, the sensor may include an integrated displacement sensor or an integrated displacement sensor and temperature sensor in combination, as well as any other suitable sensor desired for use in monitoring the movement of the faces of a flange or gasket. One or more sensors, of the same or different types, may be incorporated into each flange gap.

According to another aspect, the sensor may include a magnet to provide attachment of the sensor to the surface of the flange. Alternatively, the sensor may include an adhesive to provide attachment of the sensor to the surface. In yet another aspect, the sensor may include a threaded fastener to provide attachment of the sensor to the surface.

According to another aspect, there is provided a wireless gasket sensor device, comprising a processor connected to a wireless transmitter and at least one gasket sensor, and a power source connected to power the processor, the wireless transmitter and the gasket sensor. The processor has two or more states. There is at least one internal control element for sensing one or more predetermined conditions, the internal control element switching the processor between states based on the occurrence of at least one predetermined condition. A molded body encloses at least the processor, the wireless transmitter, and the internal control sensor such that the internal control sensor is physically isolated within the molded body.

According to another aspect, the molded body may also enclose at least one of the power source and one or more sensors connected to the processor.

According to another aspect, the processor may be connected wirelessly to a sensor that is external to the molded body or to an external sensor by conductors where a portion of the conductors is enclosed in the molded body, or both.

According to another aspect, at least one internal control element may be an accelerometer, and at least one predetermined condition may be the detection of one or more predetermined accelerations. At least one internal control element may be an RF transponder, and at least one predetermined condition may be the introduction or removal of an RF interrogator from its detection radius. At least one internal control element is a magnetic sensor, and at least one predetermined condition may be the introduction or removal of a magnetic element on an outer surface of the molded body. At least one internal control element may be a electromechanical switch, and at least one predetermined condition may be the actuation of the switch. At least one internal control element may be a temperature sensor or a non contact temperature sensor, and at least one predetermined condition may be a temperature cycle. At least one internal control element may be a gyro, and at least one predetermined condition may be the movement of the molded body.

According to another aspect, the molded body may enrobe at least the processor, the wireless transmitter, and the internal control sensor in a single piece construction.

According to another aspect, the at least one sensor may measure at least one of flange alignment, flange unloading, stud or bolt failure, gasket unloading, gasket creep, gasket disintegration and gasket failure.

According to another aspect, the at least one sensor may measure at least one of strain, cracks, crack propagation, motion, shock, acceleration, tilt, inclination, pressure, light, radiation, sound and chemical compounds.

According to another aspect, the processor may be programmed to process sensor data from the sensing element according to an algorithm and transmit the processed data by the wireless transmitter.

According to another aspect, the wireless transmitter may be a wireless transceiver.

According to another aspect, the gasket sensor device may comprise an attachment for attaching the gasket sensor to an object. The attachment may be at least one of a magnet, at least one welding flange, strapping, or an adhesive compound.

According to another aspect, the processor may be configured to operate as a node in a sensor network.

According to another aspect, there is provided a method of operating a wireless gasket sensor device, comprising the steps of: providing a wireless gasket sensor device as described above; configuring the internal control element to switch the processor between states upon the occurrence of at least one predetermined condition; and applying at least one predetermined condition to the internal control element.

According to another aspect there is provided a method to determine the pressure that the seal is under, and in particular, to determine any pressure variance around the course of the seal. This could be used to determine if the seal member is unseated, seated properly and evenly, and tightened under the appropriate compression or torque. In addition, it would be advantageous to be able to sense the contained fluid pressure being exerted onto the seal to ascertain if a leak path has been initiated there through.

According to another aspect, there is provided method to calibrate the sensor to provide a quantitative measure of the force, pressure or displacement, or any combination thereof, at the location of the sensor.

According to another aspect, there is provided a method to measure alignment of the sealing surfaces before the seal is compressed.

According to an aspect, there is provided a seal integrity sensor device, comprising a force sensor integrally formed within an elastic compressible material, the elastic compressible material having a first surface and a second surface opposite the first surface, the force sensor generating a signal in response to a compressive force applied to the first and second surfaces, the signal being indicative of the compressive force.

According to another aspect, the signal may be proportional to the displacement.

According to another aspect, the force sensor may measure at least one of flange alignment, flange unloading, stud or bolt failure, gasket unloading, gasket creep, gasket disintegration and gasket failure.

According to another aspect, the seal integrity sensor may further comprise a data collection device connected to receive data from the force sensor, the data collection device having a wireless communication module for communicating with a data network. The data collection device may comprises an attachment for attaching to an object.

According to another aspect, the force sensor may be sized to fit between flanges of a pipe connection.

According to an aspect, there is provided a wireless seal integrity sensor device, comprising a processor connected to a wireless transmitter; at least one seal integrity sensor connected to provide signals to the processor, each seal integrity sensor comprising a force sensor integrally formed within an elastic compressible material, the elastic compressible material having a first surface and a second surface opposite the first surface, the force sensor generating a signal in response to a compressive force applied to the first and second surfaces, the signal being indicative of the compressive force; a power source connected to power the processor and the wireless transmitter; and wherein the processor has two or more states and comprises at least one internal control element for sensing one or more predetermined conditions, the internal control element switching the processor between states based on the occurrence of at least one predetermined condition.

According to another aspect, the sensor device may further comprise a molded body that encloses at least the processor, the wireless transmitter, and the internal control sensor such that the internal control sensor is physically isolated within the molded body. The molded body may further enclose at least one of the power source and one or more sensors connected to the processor. At least one sensor may be external to the molded body and the processor is connected wirelessly to the at least one external sensor. At least one sensor may be external to the molded body and the processor is connected by a wired connection, where a portion of the wired connection is enclosed in the molded body. The molded body may enrobe at least the processor, the wireless transmitter, and the internal control sensor in a single piece construction.

According to another aspect, at least one internal control element may comprise one or more of: an accelerometer, and at least one predetermined condition comprises detecting one or more predetermined accelerations; an RF transponder, and at least one predetermined condition comprises introducing or removing an RF interrogator from its detection radius; a magnetic sensor, and at least one predetermined condition comprises the introduction or removal of a magnetic element on an outer surface of the molded body; a temperature sensor, and at least one predetermined condition comprises detecting a predetermined temperature; and a gyro, and at least one predetermined condition comprises detecting a predetermined movement.

According to another aspect, the at least one sensor may measure at least one of flange alignment, flange unloading, stud or bolt failure, gasket unloading, gasket creep, gasket disintegration and gasket failure.

According to another aspect, the processor may comprise instructions to process sensor data from the sensing element according to an algorithm and transmit the processed data by the wireless transmitter.

According to another aspect, the wireless transmitter may comprise a wireless transceiver.

According to another aspect, the processor may be configured to operate as a node in a sensor network.

According to an aspect, there is provided a method of operating a wireless seal integrity sensor device, the method comprising the steps of:
providing a wireless seal integrity sensor device, the wireless seal integrity sensor comprising a processor connected to a wireless transmitter; at least one seal integrity sensor connected to provide signals to the processor, each seal integrity sensor comprising a force sensor integrally formed within an elastic compressible material, the elastic compressible material having a first surface and a second surface opposite the first surface, the force sensor generating a signal in response to a compressive force applied to the first and second surfaces, the signal being indicative of the compressive force; and a power source connected to power the processor and the wireless transmitter;
installing the wireless seal integrity sensor at a location at which configuring the internal control element to switch the processor between states upon the occurrence of at least one predetermined condition; and
applying at least one predetermined condition to the internal control element.

According to another aspect, the force sensor may be installed between pipes ends in a pipe connection.

According to an aspect, the force sensor may be installed by inserting the force sensor between two components in a connection.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 shows schematically a basic wireless mote sensor network.

FIG. 2 shows schematically a wireless mote.

FIG. 3 is a block diagram showing the wireless mote wirelessly receiving power from an external power source.

FIG. 4 shows a wireless mote situated adjacent to and surrounding a sensor.

FIG. 5 is a state diagram of the microprocessor that changes states based on a gesture.

FIG. 6 is a state diagram of the microprocessor that changes states based on different gestures.

FIG. 7 is a state diagram of the microprocessor that changes states based on a gesture and an event.

FIG. 8 is a block diagram of functions performed by installed software.

FIG. 9 illustrates one method for management of data received from wireless motes.

FIG. 10 shows a schematic of the synchronization of motes.

FIG. 11 illustrates an algorithm for quasi-asynchronous to isochronous to synchronous conversion of data from wireless motes.

FIG. 12 is a perspective view of a gasket sensor device.

FIG. 13 is a side view in section of a gasket sensor device.

FIG. 14 is a side view in section of a gasket sensor device positioned in the gap between two surfaces

FIG. 15 is a perspective view of a gasket (gap) sensor device

FIG. 16 is a perspective view in section of a gasket sensor device.

FIG. 27 is a perspective view of the sensor installed on a pipe flange

FIG. 18 is a perspective view in section of the sensor installed on a pipe flange

FIG. 19 is a side elevation view of the sensor installed on a pipe flange

FIG. 20 is a graph showing conductance versus distance (displacement)

FIG. 21 is a perspective view of a wear sensor.

FIG. 22 is a side elevation view of a wear sensor.

FIG. 23 is a side elevation view in section of a wear sensor.

FIG. 24 is a block diagram of a wear sensor in connection with a data and communication module.

FIG. 25 is a partially transparent side elevation view of a wear sensor installed in a pipeline.

FIG. 26-28 are side elevation views in section of a wear sensor installed in a sidewall of an industrial component that is subject to wear.

FIG. 29-32 are examples of wear gage PCBs.

FIG. 33 is an exploded view of a wear sensor and data connection.

FIG. 34 is a chart showing readings from wear sensors at different locations in a wear test facility.

### DETAILED DESCRIPTION

There are many devices known to those skilled in the art for sensing various properties of matter, physical environment, and status of equipment. Typically, the data acquired by the sensor are stored and compared to predetermined values. In some cases, each reading is transmitted electronically to a central processor for evaluation. Alternatively, data may be transmitted electronically to a controller at intervals or when the data acquired fall outside predetermined limits.

Data may be transmitted using RF. In one example, this may be done as described by Powers et al. in U.S. Pat. No. 5,381,136.

Sensors may be isolated from harmful environments, such as corrosive atmospheres, or hazardous conditions, such as combustible gases, by containment of the sensor within a housing.

In other sensing devices, there are requirements including available power, reliability, and protection of and from the ambient environment that limit their applicability and which reduce their utility.

In particular, sensors attached to moving components of equipment, rotating components, components subject to wear may be themselves subjected to severe stresses, vibrations, or wear. It is desirable that sensors be small and have minimal mass to minimize imbalance that could lead to wear to failure. Additionally, components at interior points of equipment can have limited visibility or “line of sight” to the other sensors and data collection points and can be “blind”. It is desirable that sensors have the capability to operate independently of all other devices, and capability to transmit data wirelessly. Further, it is desirable that such systems be capable of operating in hazardous, harsh as well as laboratory or environmentally controlled environments.

The present discussion relates to wireless sensor devices, or sensors, that are intrinsically safe and easy to install by direct attachment to a component of equipment, and easy to use as it includes a sensor device and a wireless mote. Generally speaking, the sensor device provides readings to the wireless mote, and the wireless mote is used for control and communication. however, it will be understood from the discussion herein that these functions may be divided differently. For example, the sensor device may be formed within the wireless mote, or certain functions may be externalized from the wireless mote. Accordingly, the terms “mote” and “sensor” may be used interchangeably herein to refer to either the communication and control module, or the sensor device, or both the communication module and sensor device together. The communication module of the mote preferably contains within a protective body all components necessary for its intended purpose, such as additional components for sensing, communications, a tap sensitive user interface, a durable power source and ultra-low power operation. Advantages accrue from inclusion of a sensor interface and data acquisition components, memory, wireless transceiver, long life battery, a magnetic sensor, and capability for software over radio updates, data logging, and power management.

This device may be used to sense the status of a component of equipment, and may be designed to provide some or all of the following advantages:
can be securely affixed to or installed within a component of equipment located at any convenient position within that equipment;
is isolated from the ambient conditions so as to protect it against hazards and so that it is not at risk to cause a hazard;
can acquire data, log data, store data and, when required, handle, analyze and compare data;
can transmit all data, accumulated blocks of data, or selected data; and
can receive commands for operating the data accumulation, storage and transmission functions.

The mote, or sensor, contains a source of power that may be batteries or, alternatively, a mote may be capable of being recharged so as to extend its operating life. Alternatively, the mote may scavenge or harvest power from its environment.

Further, to minimize power consumption, the mote may be capable of conserving power through power management functions such as operating one or more functions only when required and selectively controlling power to one or more components.

The position of a mote that is attached to moving equipment at any time can be determined using methods such as those described by El-Sheimy et al. in Report on Kinematic and Integrated Positioning Systems, FIX XXII International Congress, Washington, D.C., Apr. 19-26, 2002.

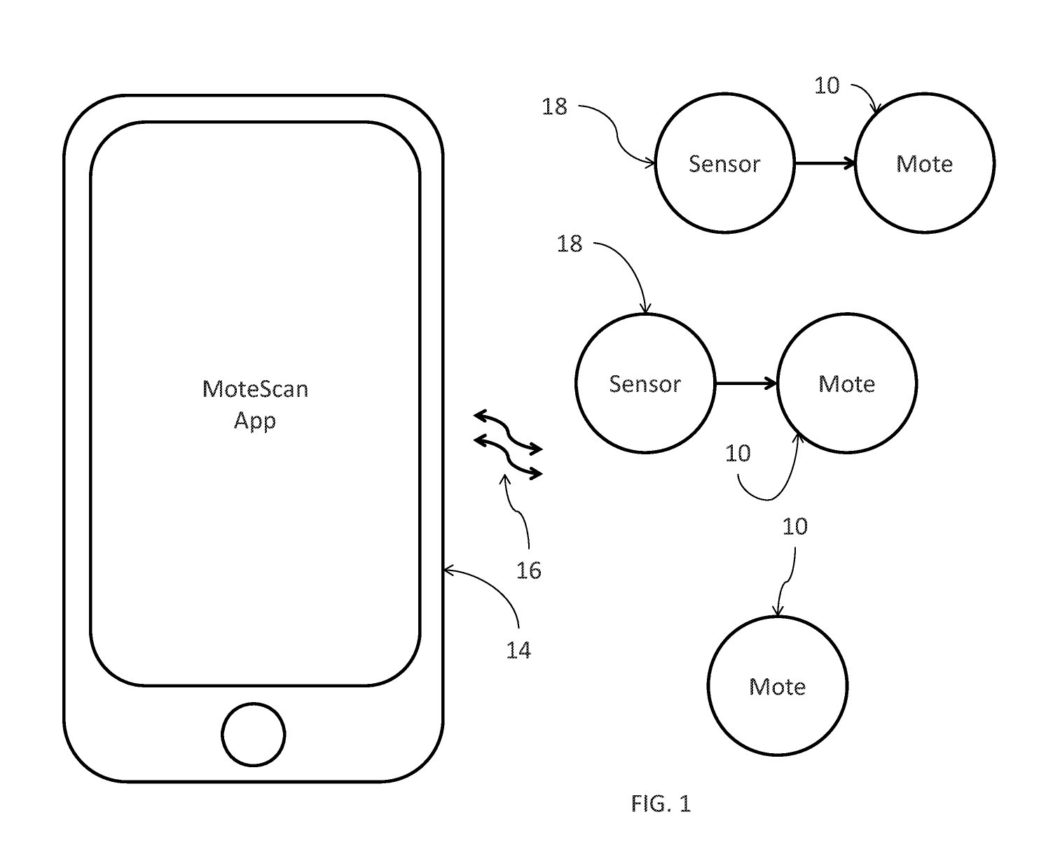

To these ends, a wireless mote 10 now will be described with reference to FIG. 1 through 5. In particular, as a non-limiting example, a wireless mote will be described for monitoring a seal within a component of equipment. It will be recognized that there are many other applications for which there is use of an alternative design of wireless mote 10 based on similar design aspects, some of which will be described below. An exhaustive consideration will not be provided as there are many variations that may be possible, as will be recognized by those skilled in the art.

Referring to FIG. 1, at least one wireless mote 10 is in wireless communication via link 16 with a data communication device 14. Wireless mote 10 may also be in communication with another wireless mote 10. Data communication device 14 may also be in communication with a wireless mote 10 via another wireless mote 10. Data communication device 14 communicates with wireless mote 10 for the purpose receiving, logging, analyzing and processing data received from wireless mote 10. In a preferred embodiment, mote 10 has within a communications software stack that is compliant with a standards based communication protocol such as Bluetooth, Bluetooth Low Energy (“BLE”), 802.15.4, 802.15.4e, Zigbee, Contiki, et al. Data communications device 14 could be any form of computer such as a embedded computer, a desktop computer, a portable or laptop computer, a smart phone such as an iPhone, Blackberry, Android, etc., or a tablet computer such as an iPad. Data communications device 14 may have additional wired and wireless interfaces such RS-232, Ethernet, Modbus, controller area network (“CAN”), Bluetooth, NFC, or any one of the 802.11 “WiFi” standards or a proprietary interface. At least one sensor 18 is electrically connected to wireless mote 10.

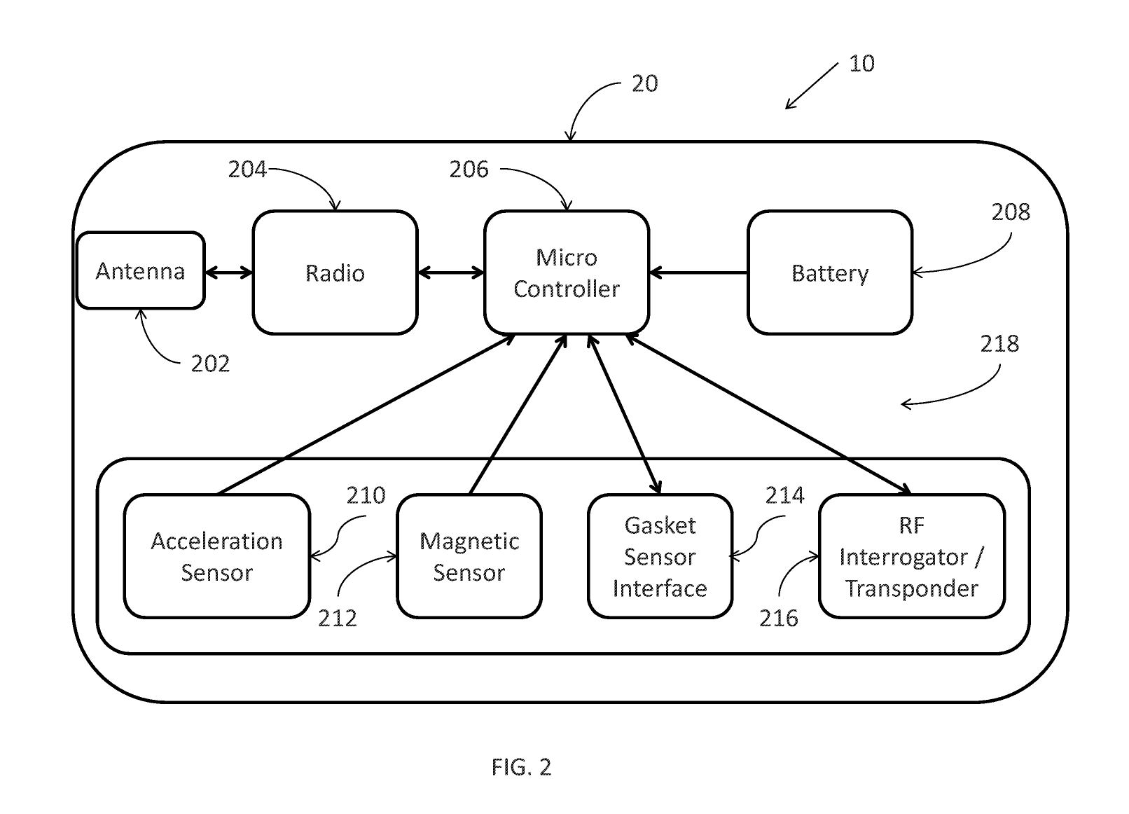

Referring to FIG. 2, wireless mote 10 includes a body 20 within which other components 218 are completely sealed. Body 20 isolates these other components from hazardous environments. Body 20 is preferably a molded body having all the internal components secured within it. In a preferred example, the internal components are assembled, and a urethane material is injected around the components to create a monolithic body encapsulating the components without any internal cavities, such that each component is embedded within the urethane. It will be understood that body 20 may be manufactured from any material that isolates interior components of wireless mote 10 from the ambient environment while allowing radio coupling between antenna 202 and data communications device 14 or other type of gateway. It has been found that body 20 manufactured from urethane meets these requirements for use in several environments. Preferably, the material will be rigid, heat resistant and impermeable.

Referring to FIG. 2, sealed within body 20 are a microcontroller 206, sensor interface and conditioning electronics 214, wireless transceiver 204, at least one antenna 202, and a power source 208. One or more sensors may be interfaced to other components 218 within body 20. Sensors may be any suitable sensor, such as one or more magnetic sensor 212, RF transponder 216, temperature sensor/transducer, pressure transducer, accelerometer 210, strain gauge, crack sensor, wear gauge, etc. and may be powered by mote 10 or have an independent power source. Furthermore, sensors 210 and 212 may also be interfaces for other sensors, as is the case with gasket sensor interface 214. Other components may be included within the body such as program memory which is preferably flash memory or FRAM memory, data memory (not shown) which is preferably flash memory or FRAM memory, and a power management and monitoring.

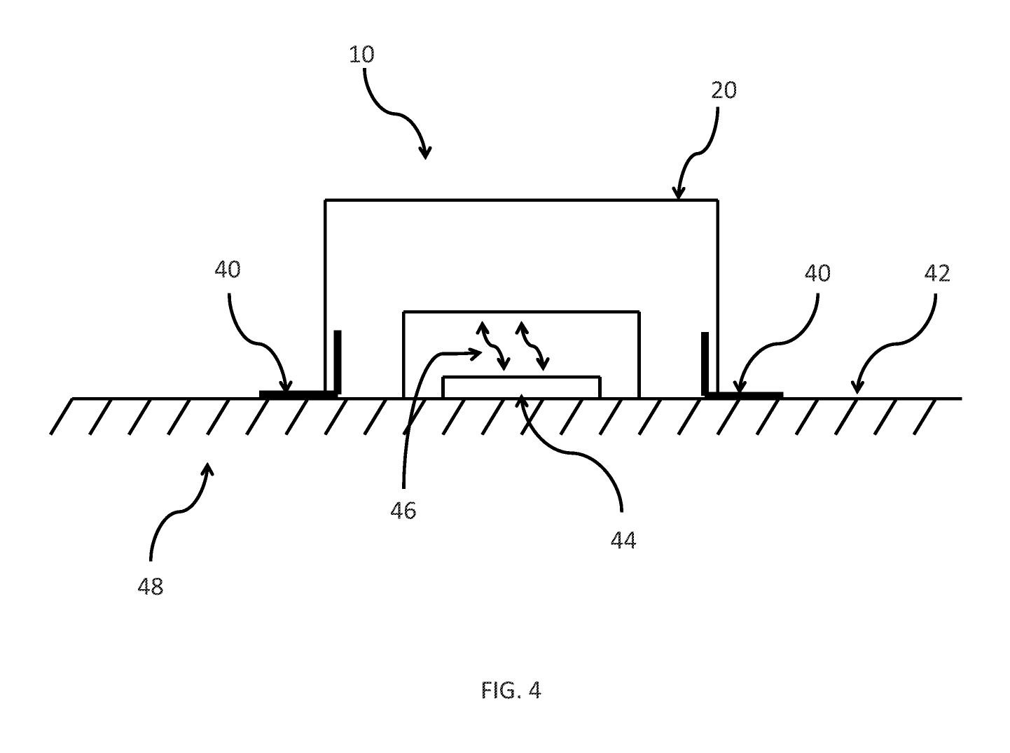

Sensor elements may be embedded within body 20, or, referring to FIG. 4, alternatively, sensor 44 may be external to body 20 and may be in wireless communication via a wireless link 46 with an adjacent wireless mote 10. Wireless link 46 may comprise a radio link comprising a transponder (not shown) embedded in sensor 44 and an interrogator 36 embedded in wireless mote 10. Alternatively, wireless link 46 may be an inductively coupled link. The inductively coupled link may link data, may link power, or both in combination to sensor 44. In FIG. 4, wireless mote 10 is shown attached to a surface 42 of a component 48 of equipment and situated surrounding sensor 44. As shown, wireless mote 10 is attached at surface 42 by welding metal tabs 40 of wireless mote 10 to surface 42. Alternatively, body 20 may be attached to surface 42 using epoxy compounds. Alternatively, a permanent magnet within body 20 may couple with a magnetic material in component 48 and maintain a force of attraction to keep the body 20 in contact with surface 42.

Referring to FIG. 2, components 218 within the body 20 may provide capability to sense at least one of tilt, vibration or acceleration integrally with wireless mote 10. A signal provided from one of components 218 may be used to activate and control actions such as logging and temperature sensing. Such activations can be used to interface the operation or functions of the wireless mote with the user. Further, wireless mote 10 may be attached to a rotating component of equipment, for example a rotating shaft, so as to measure the environment, behaviour and phenomena experienced by the component, including vibration, acceleration, etc. and so provide data on the status of said component during operation and to provide an alarm when predetermined values for criteria are exceeded or to acquire data or perform a task according to the orientation or rotational position of the wireless mote 10. Component 218 could also integrate into the power management functions to wake the sensor from a low power mode to become active upon the occurrence of a predetermined condition, such as sensing motion of the attached equipment. Preferably, the wake/sleep, or active/inactive state of wireless mote 10 is controlled by an element that is distinct from the wireless transmitter used to transmit the sensor data. For instance, wake/sleep when the sensor is in a certain orientation or motion, or wake/sleep upon a certain magnitude of shock, or wake/sleep on a certain amount of vibration. Alternatively, the power management functions such as wake/sleep could be activated on a “gesture” which is a combination or pattern thereof of orientation, motion, shock and vibration. In yet another embodiment, the gestures, or tap sensitive interface, could be used to control other functions of the sensor. Other examples include an RF transponder (such as a radio frequency identification tag), where an RF interrogator that comes into range, or leaves the range, of the RF transponder in wireless mote 10 would cause it to change states, and a magnetic sensor that may be either an element that senses a magnetic field or a switch that is activated by a magnetic field, could be activated by a magnetic element being placed on or near an external surface of the wireless mote 10. Moreover, the magnetic element could be moved in a three dimensional pattern to form a gesture. Generally speaking, the wireless transmitter uses a significant portion of the available power. By providing these other elements, which use little or no power, to switch the wireless mote between wake/sleep states, it allows more power to be conserved. For example, the accelerometers required for the gestures require little power, or may be powered by the gesture itself, and the RF transponder may be designed to be powered by the RF signal it receives from the RF interrogator. Similarly, the magnetic sensor requires little or no power between switching states.

Other power management options include harvesting energy from the environment, such as thermal energy, solar energy, kinetic energy, cathodic protection energy, or energy from radio waves.

Referring again to FIG. 2, power source 208 may be at least one battery, or may be a rechargeable electrical power storage unit for storing electrical power harvested from solar energy, vibration, heat, cathodic protection, or an inductively coupled electrical source, coupled inductively to wireless mote 10 so as maintain the seal provided by body 20.

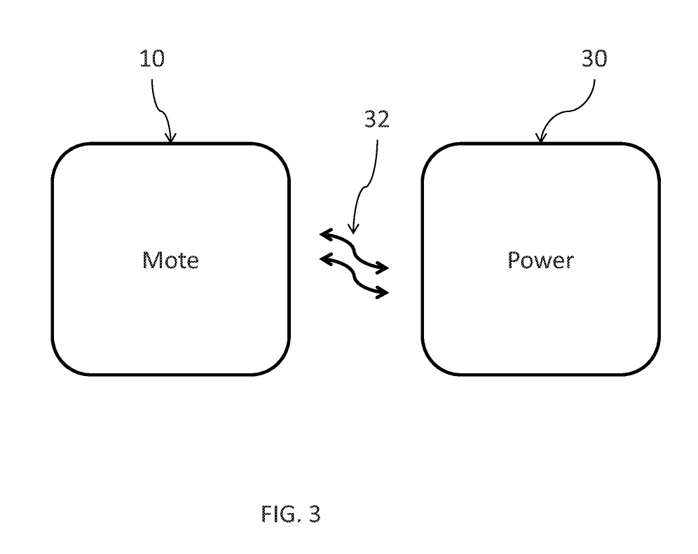

Alternatively, referring to FIG. 3, wireless mote 10 may be powered by an inductively coupled 32 power source 30. Power source 30 could be any form of power source such as a battery. Alternatively, wireless mote 10 may recharge its internal battery through inductively coupled 32 power source 30.

Power management is implemented to reduce power consumption to improve lifetime of power source 208. Multiple level power saving techniques may be used by programming wireless mote 10 to perform one or more of the following means:
operating during sampling only, so that the sensor is in an on state only just before a reading, and then is switched off;
deep sleep mode, in which an external signal is required to reactivate wireless mote 10;
operating only the Rx transmitter;
operating only the Rx receiver for supervisory channel received signal strength indicator detection of a “wake up” code;
powering only clocking modes when other modes are switched off; and
operating Tx radio/Rx on a periodic basis, that is, duty cycled.

Referring to FIG. 2, magnetic sensor 212 may be used to interrupt the power to the mote circuits and to reconnect. In general, motes are programmed to periodically “wake up” and go to “sleep” with the objective of saving power or to extend the life of one or more components. Typically, this is done in one of two manners. The first manner is to program “on” times for reading and data logging, e.g. the mote goes to “sleep” at a specific time and wakes up at a prescribed time or after a prescribed interval to take readings, and the cycle is repeated. The second manner to conserve power is to be in low power mode for the majority of time and to be fully powered up only at prescribed times at which it is to determine if there are messages received from controller 14 or an external device such as a computer; or to communicate with or download data to a data management system 14 or external device. In either case the mote is not necessarily “on” and capable of communications at all times. However, by keeping the previous state of the mote, including its view of wake/sleep state, projecting forward in an external database, then a user can talk to one or more motes in a virtual sense, i.e. it becomes possible to communicate with a database remote from both motes and user and thereby the database will provide the information as if the mote were active and in communication with the user. Thus, for example, a user at one site utilizes a coordinator (e.g. a master mote) to communicate to one or more motes, even when those motes are asleep.

A user normally would perceive that sleeping motes do not appear to exist because they are not in communication with other devices. However, user's computer can communicate with the database which has historical and forward projecting information. In this case, the user's view would merge the live mote data with the database data and show the real number of motes at any location. The database would also give information gathered during an earlier interaction to provide current status data, for example that a particular mote presently is “asleep” and that it will “wake up” at a particular time. In this manner, persistent forward and backward synthesis and correlation of the data will improve immensely a user's interaction with the wireless motes 10 when compared to prior art systems.

Additionally, magnetic sensor 212 can be activated remotely so as to “wake up” one or more specific wireless motes 10.

Referring to FIG. 4, metal tabs 40 are optionally provided to enable attachment of wireless mote 10 to a component of equipment. Metal tabs 40 may be attached to the component by welding or by resilient adhesive. As can be seen, metal tabs 40 are partially embedded in wireless mote 10. Metal tabs 40 may be dielectrically isolated from microprocessor 14 of wireless mote 10 to prevent interference or effects from electrical charging at the component.

Referring to FIG. 2, in one example, microcontroller 206 may be reconfigured wirelessly. This process may involves using Flash or other non volatile memory to maintain a record of the configuration or “personality” of wireless mote 10, and to record data. Further, memory storage can be used to record a copy of the mote's software program which can be programmed into the microcontroller 206.

Internal Control Elements

Internal control elements are included in body 20 to allow a user to change the function of the embedded firmware between states. As body 20 is preferably a molded body solid with all the components embedded within the material, the one or more internal control elements will be physically isolated from an exterior surface of body 20. This allows internal control elements to change the state of the mote without compromising the inherently safe characteristics of body 20. Internal control elements may, for example, change the state to communicate in a different manner, or change between a wake/sleep state to help conserve power or otherwise. Referring to FIG. 2, a block diagram of an embodiment of wireless mote 10 is shown in a body 20. Body 20 contains a number of internal control elements 218 in communication with microcontroller 206, each of which can be used to control the wake/sleep state of wireless mote 10, as discussed previously. It will be understood that only one internal control element 218 is required to allow the user to change state in this manner, however multiple elements may be included to enhance functionality.

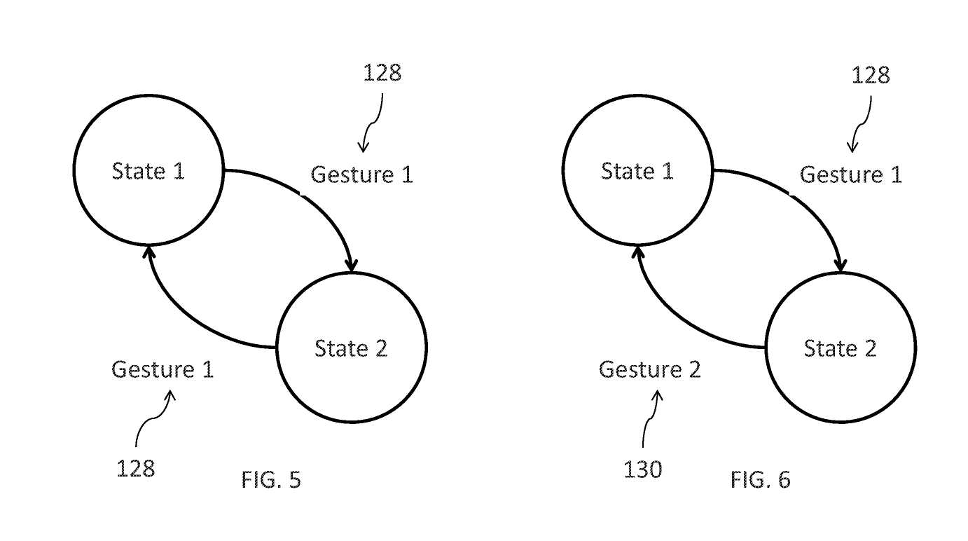

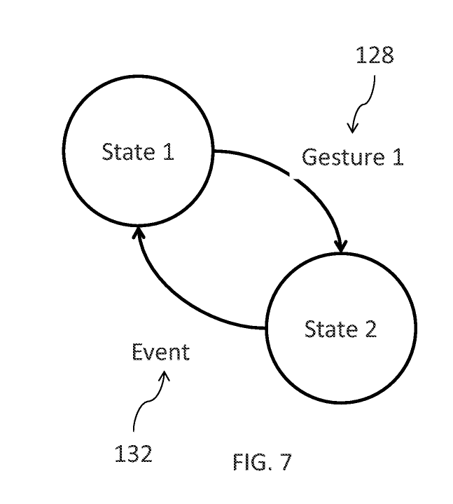

In the case of an acceleration sensor, referring to FIG. 5, a gesture 128 may cause the function of the embedded firmware to change state. In this embodiment the change of state from State 1 to State 2 and back uses the same gesture 128. In the embodiment shown in FIG. 6, gesture 128 may cause the function of the embedded firmware to change from State 1 to State 2, while another gesture 130 causes the function to change from State 2 to State 1. In other embodiments, a predetermined event 132, rather than gesture 128, may cause the state to change. This is represented by FIG. 7, where gesture 128 causes the function of the embedded firmware to change from State 1 to State 2, and change of state back to another state occurs on event 132 such as an elapsed period of time or a programmatic condition. While two states have been depicted for simplicity, it will be understood that there may be more than two states, and different types of gestures or events that trigger a change of state, or a change of state may require both an event and gesture. Alternatively, a change of state may require the appropriate input into more than one internal control element. Other possibilities will be recognized by those skilled in the art, and will depend on the requirements and preferences of the user.

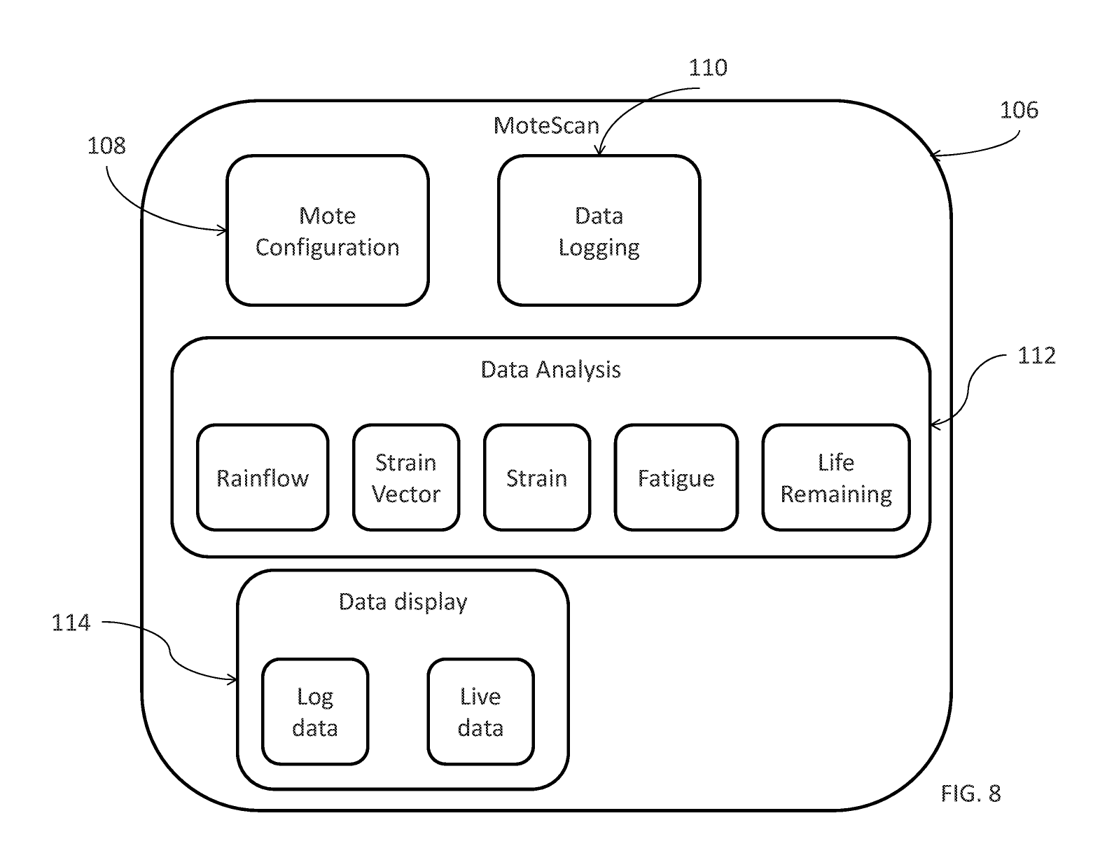

Referring to FIG. 8, the functions of a preferred implementation of the software 106, referred to as “MoteScan” are illustrated and include mote configuration 108, mote licensing (not shown) and data logging function 110. Mote configuration 108 allows setting various parameters for the mote, which may include sampling rate, sampling period, sampling duration, sampling repetition cycle and sampling signal channels. The data logging 110 stores the selected sampling signal channels to the internal memory on the mote. Mote licensing ensures that a valid license is present for the selected mote. If a license is not present, the MoteScan will not communicate with the mote or download data. MoteScan scan software 106 has the ability to analyze data in real time using data analysis algorithms 112 and display the results, including log data and live data, using data display 114. For example, software 106 may implement algorithms to calculate a strain vector, strain, fatigue, estimate life remaining, and/or a Rainflow algorithm may be applied to various histories to enable real time analysis of data received from one or more sensors 24.

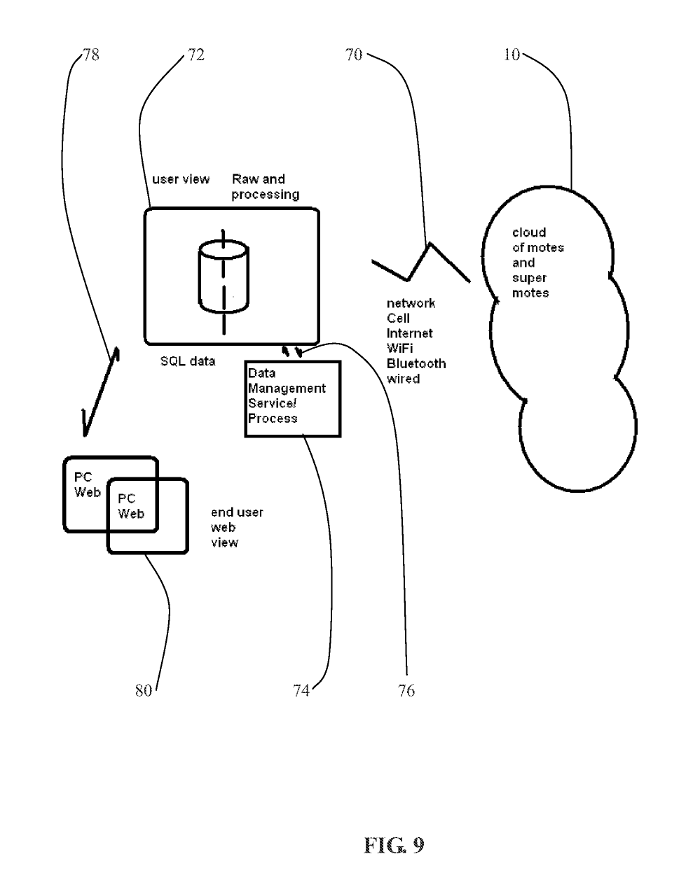

What also is required is management of data received from a plurality of wireless motes 10, for which one option is illustrated in FIG. 9. Data from wireless motes 10 is communicated by a link 70 using any of several conventional means to a database 72, for example a SQL system. Raw data and processed data are stored at database 72. Raw data is processed at a data management service system 74 in communication over link 76 with database 72. Abstracted data are communicated to an end user 80 via communications links 78, which may be web intermediated via the internet, cell phone or a Bluetooth device. Abstracted data that may be communicated include life time of one or more components of wireless mote 10, or warnings concerning readings by a sensor 24 that are outside predetermined limits, or results of rainfall data analysis performed at wireless mote 10 or data management service system 74. End user 80 can communicate commands via database 72 to wireless motes 10.

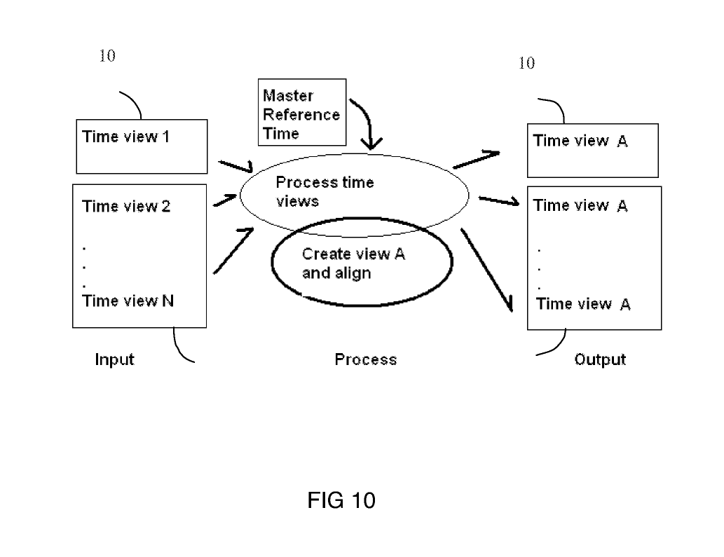

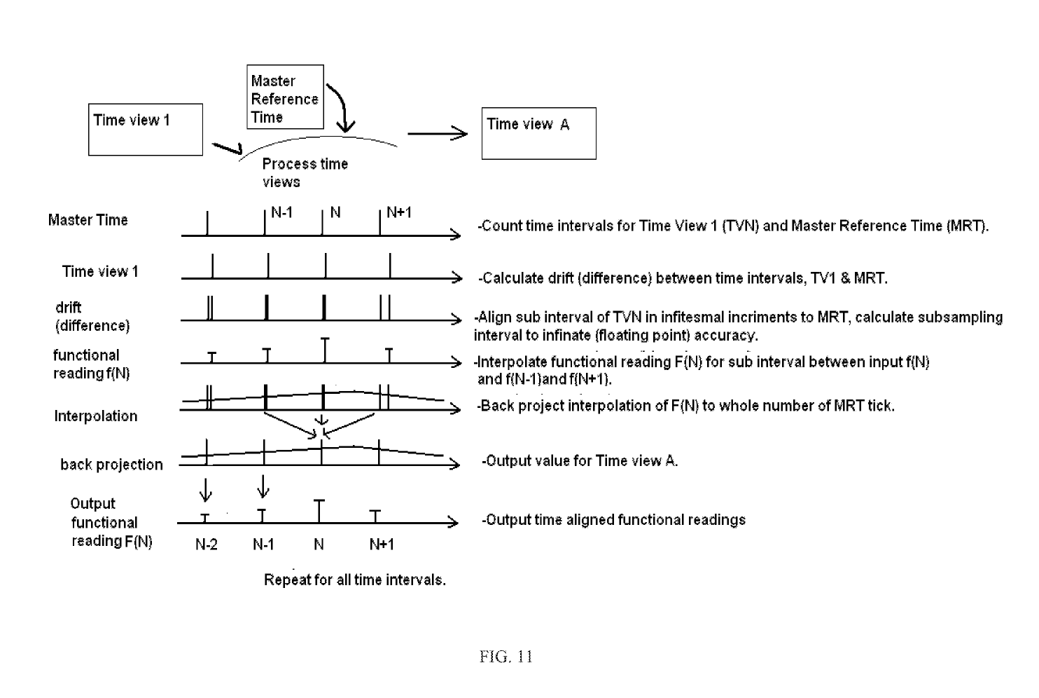

Referring to FIG. 10, advantages may be had by synchronizing time between each wireless mote 10 and controller 30 so that all wireless motes 10 operate in a synchronized manner. Referring to FIG. 11, an algorithm for quasi-asynchronous to isochronous to synchronous conversion is provided to align in multimode manner multiple asynchronous motes so that data received from said wireless motes 10 or communicated between them is synchronized before analysis.

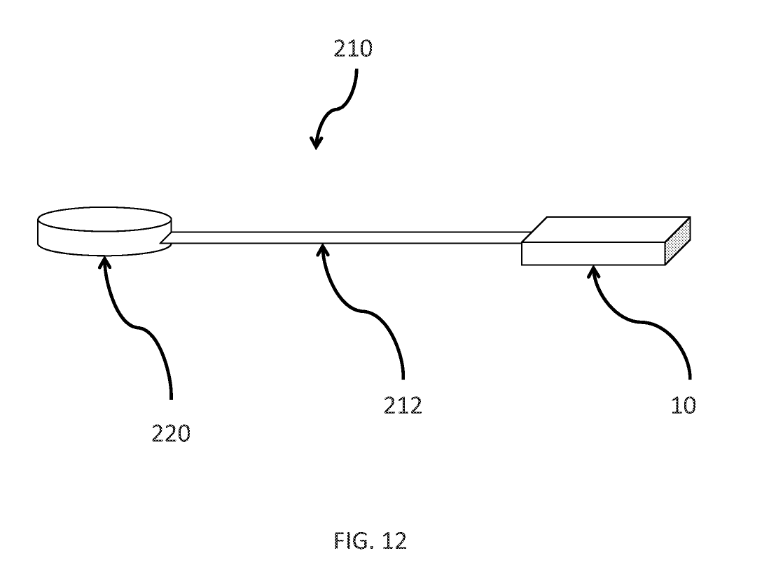

FIG. 12-22 depict examples of a wireless gasket sensor device 210. Referring to FIG. 12, wireless gasket device 210 has a gasket sensor device 220, a interconnection 212 between the gasket sensor device 220 and a wireless mote 10.

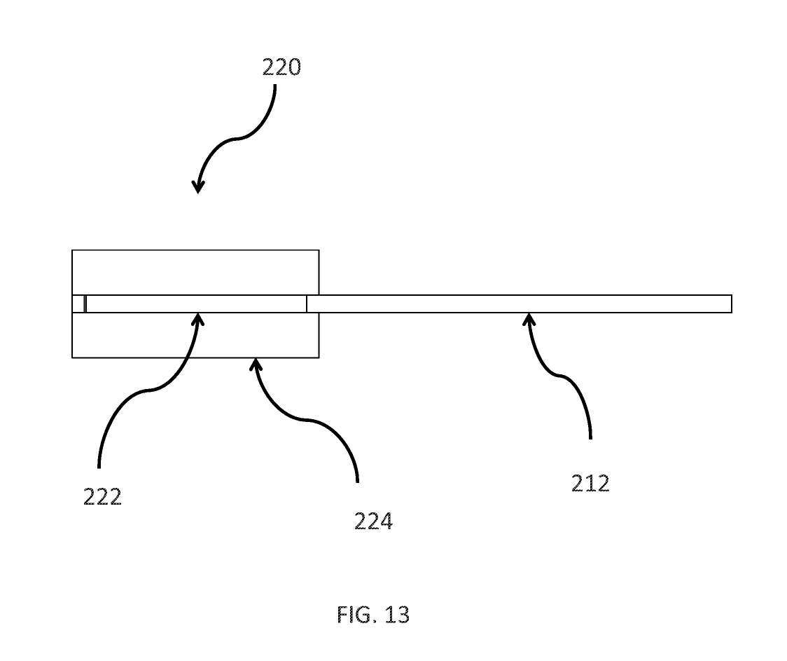

Referring to FIG. 13, a gasket sensor device 220 is shown with a force sensor 222 integrally formed within an elastic compressible material 224 and an interconnection 212. Interconnection 212 is used to electrically connect the force sensor 222 to an electronic circuit interface circuit within a wireless mote 10, as shown in FIG. 12.

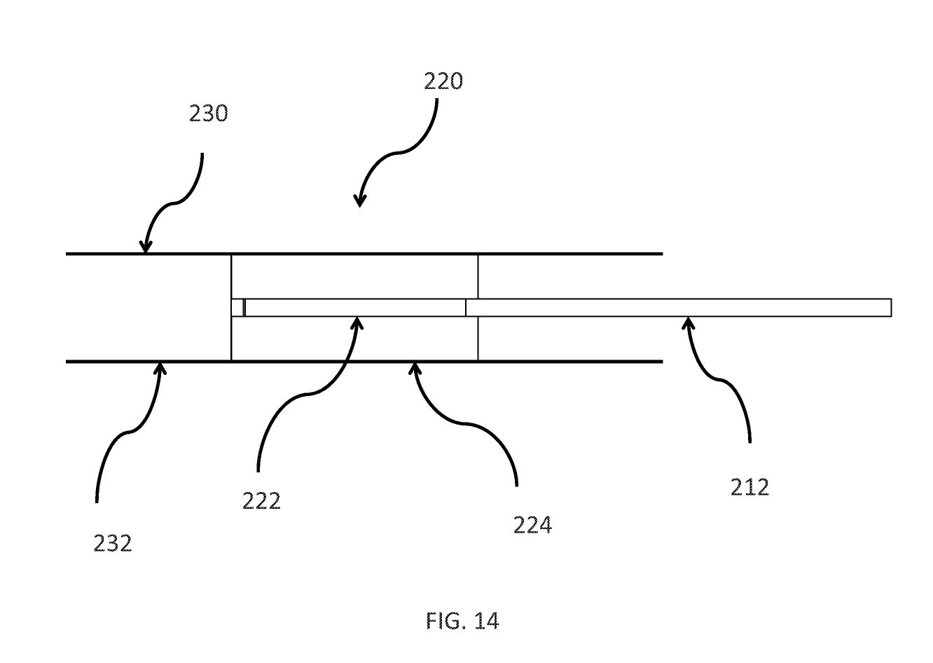

Referring to FIG. 14, gasket sensor device 220 is shown with a force sensor 222 integrally formed within an elastic compressible material 224, where the elastic compressible material 224 translates displacement of a first surface 230 relative to a second surface 232 into a force where the force sensor 222 generates an electrical signal that is proportional to the width of the gap or displacement.

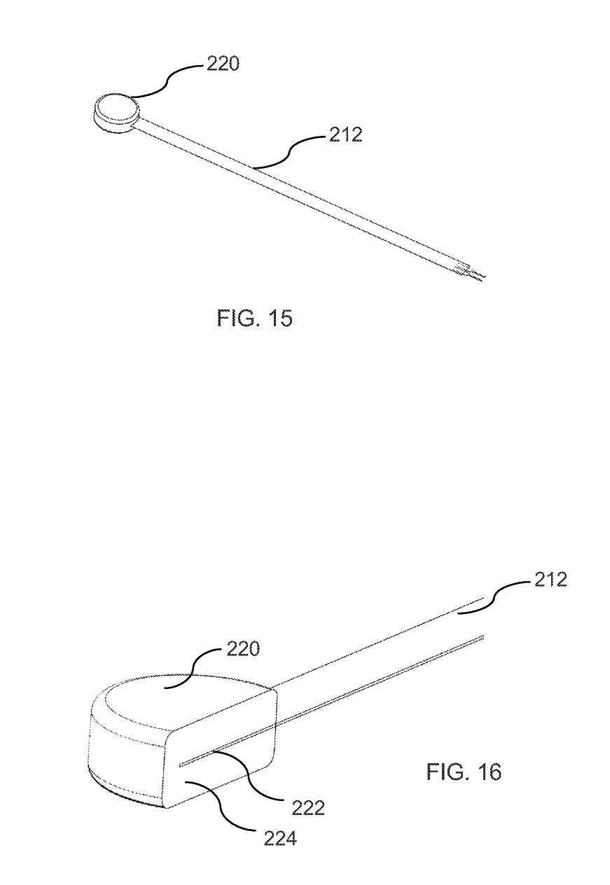

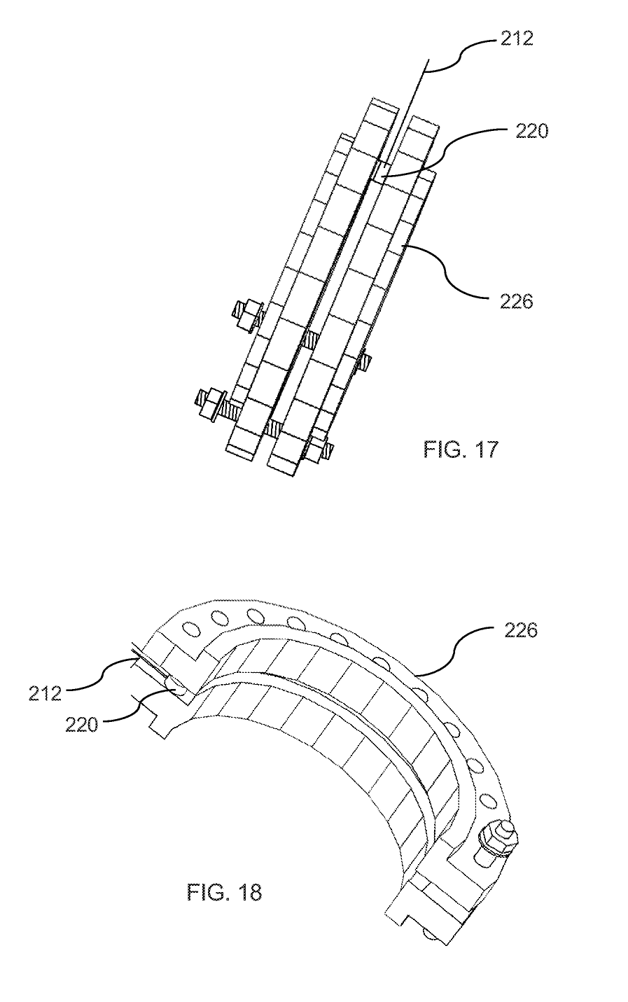

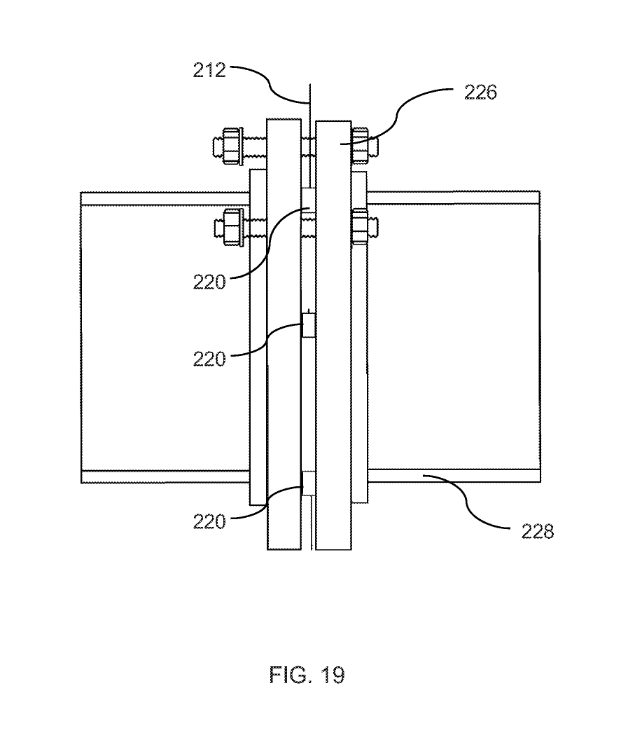

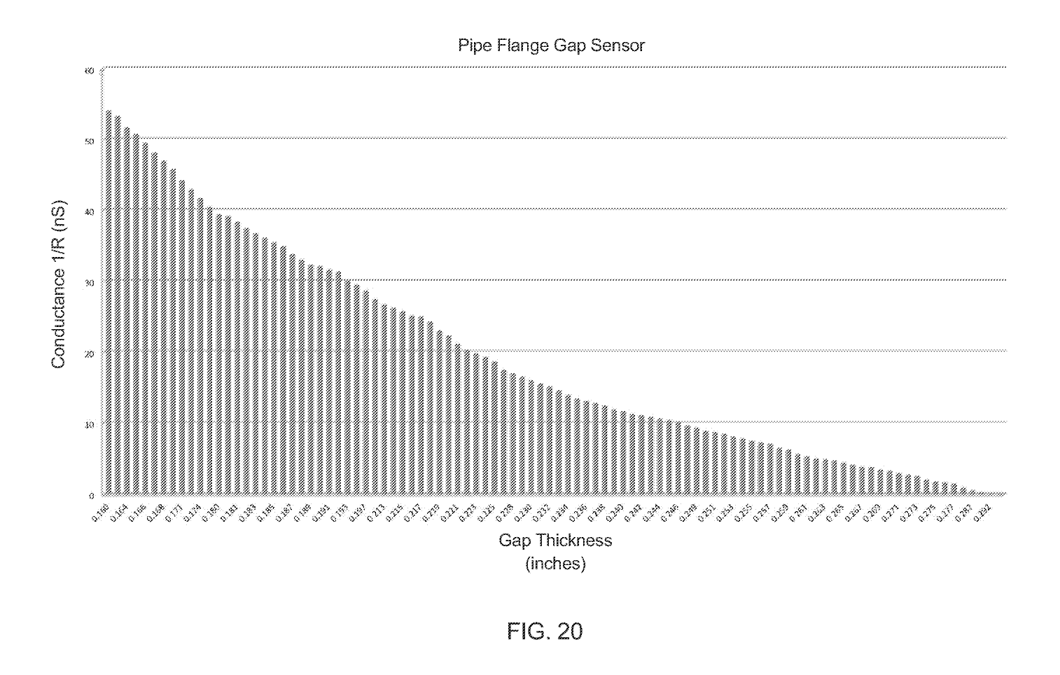

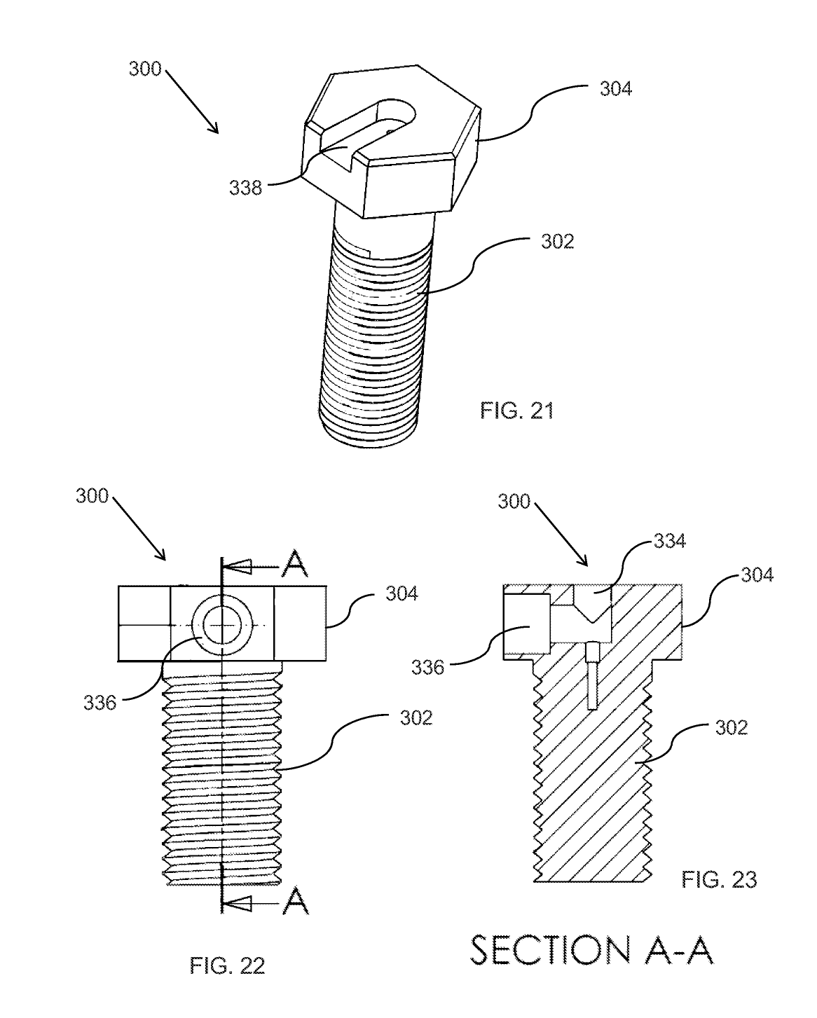

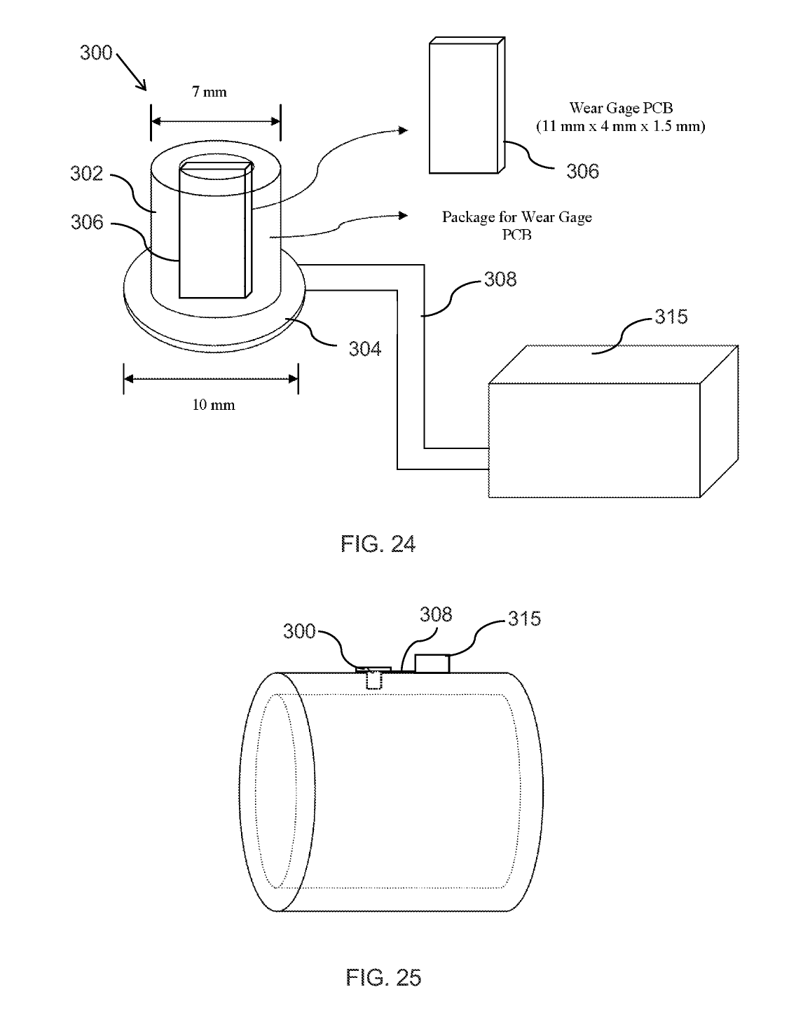

FIG. 15 shows a gasket sensor 220 and interconnection 212, which is shown in cross section in FIG. 16, with a force sensor 222 integrally formed within an elastically compressible material 224. Alternatively, mote 10 may be coupled to sensor device 220 wirelessly, such as inductively, to communicate signals and/or power.

Applications

Gap Measurement—

Most pipelines experience strain, either tensile or compressive or sheer, on their critical parts such as flanges. Invariably, this leads to misalignment of the flanges, non uniform compression of the gasket, degradation of the gasket, fatigue of the gasket material, and eventual failure of the critical component. Typical methods to measure gasket integrity include visual inspection. The sensor describe herein may be used to measure the gap (or displacement) between opposing surfaces of a flange. Generally speaking, a gasket sensor is designed to elastically compress or otherwise deform when a compressive force is placed upon it. As it deforms its electrical conductivity changes. This, coupled with the geometry of the device, as well as the number of devices being read, will give the inspector a precise reading of the amount and direction of compressive force. Moreover, alignment of the opposing flange surface may be determined by comparing the relative compression of at least two gasket sensors placed along the perimeter of the flange surfaces within the gap between the flange surfaces and using geometry to calculate the relative position the opposing surfaces.

An experiment was set up to measure conductance as a function of the compression of the sensor. The sensor was positioned between two opposing surfaces of a flange. The distance between the two surfaces was measured and the corresponding conductance was recorded. The distance was adjusted and measured and the conductance value was recorded. This process was repeated until the distance was approximately 0.5 the starting distance. The results are illustrated in FIG. 20. This graph illustrates the measured values of conductance versus displacement of the flange gap (distance between the opposing surfaces of the flange). This information was used to calibrate the displacement of the sensor to the conductance of the force sensor.

FIGS. 17-19 illustrate the positioning three sensors 220, each 120 degrees apart along the perimeter of a flanged connection 226 of a pipeline 228, shown in FIG. 19.

Wear Measurement—

Referring to FIG. 21-34, an example of another type of sensor device, such as may be useful for measuring wear and referred to herein as a Wear Sensor Device (WSD) package 300 is shown, which is designed to be embedded in an object to be monitored, and may be used to monitor conditions such as wear, temperature, strain, etc. in the object being monitored. Referring to FIGS. 21-23, WSD 300 is shown as being shaped like a stud with a shaft 302 and head 304. The shaft 302 and head 304 are cylindrical, with a sensor WSD gauge printed circuit board 306 is placed within a hollow space in shaft 302 and/or head 304 as shown in FIG. 24. The shaft 302 may be smooth, threaded, or otherwise contoured. In one example, WSD 300 is designed as a NPT fitting to provide a suitable seal. The head 304 may be shaped and designed to be driven by common tools, such as a hammer or wrench. Signal wires 308 connect to the printed circuit board 306 to interconnect the WSD 300 with a data collection and/or transmission device, such as a mote as described above. In addition to signal wire, there may be wires to supply power to the WSD. Moreover, there may be wires to provide digital communication to the WSD device.

Alternatively, inductive coupling may be used couple signals to the WSD circuit board 306 or to couple signals and power to the WSD circuit board 306.

FIG. 25 shows a typical installation to the wall of a carbon steel pipe 310. The stud 300 may be installed in various types of materials, such as stainless steel, urethane, iron and other types of plastic. Moreover, the pipe 310 or other object into which WSD 300 is installed may be a constructed of composite or layered materials such as carbon steel with a carbon chrome overlay or urethane overlay. Other types of structural and components can be measured including fasteners such as bolts, structural plates, wear plates, structural support members including beams, I-beams, posts, headers, hangers and tie rods, storage tanks, turbine components, airframe components, civil infrastructure components including components of bridges and bridge decks, structural components of buildings including pilings, footings, counter balance, anti earthquake components, etc. Common thicknesses to be measured may include 3.5 mm, 5.0 mm, 6.5 mm, 8.0 mm, 9.5 mm, 11.0 mm. Dimensions for a suitably sized WSD 300 are included in FIG. 24, although it will be understood that these are illustrative only and may be changed based on the preferences of the user and the requirements of the situation.

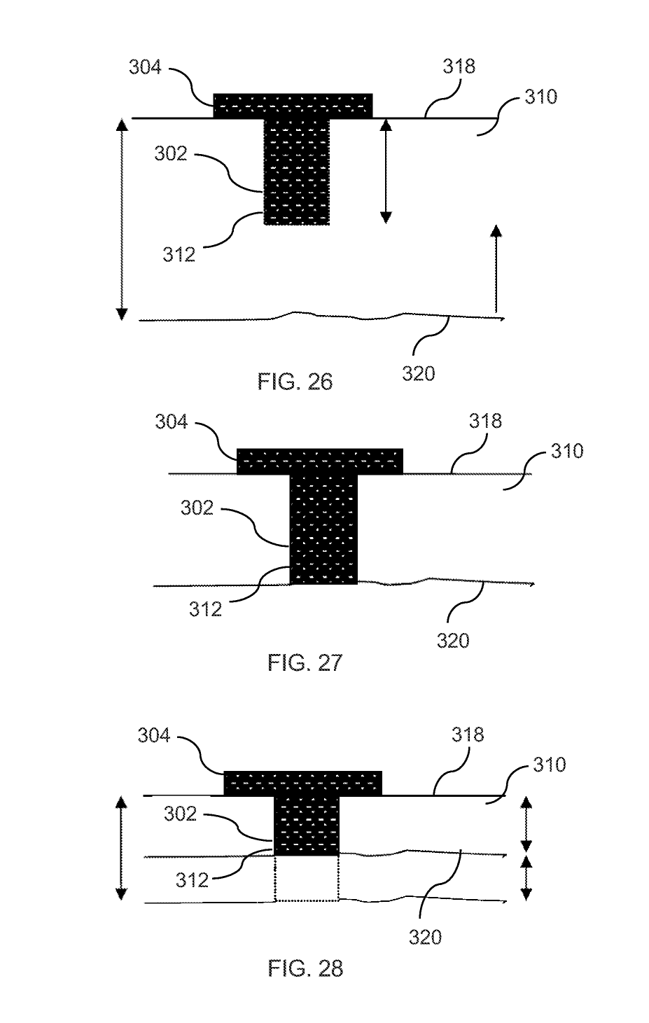

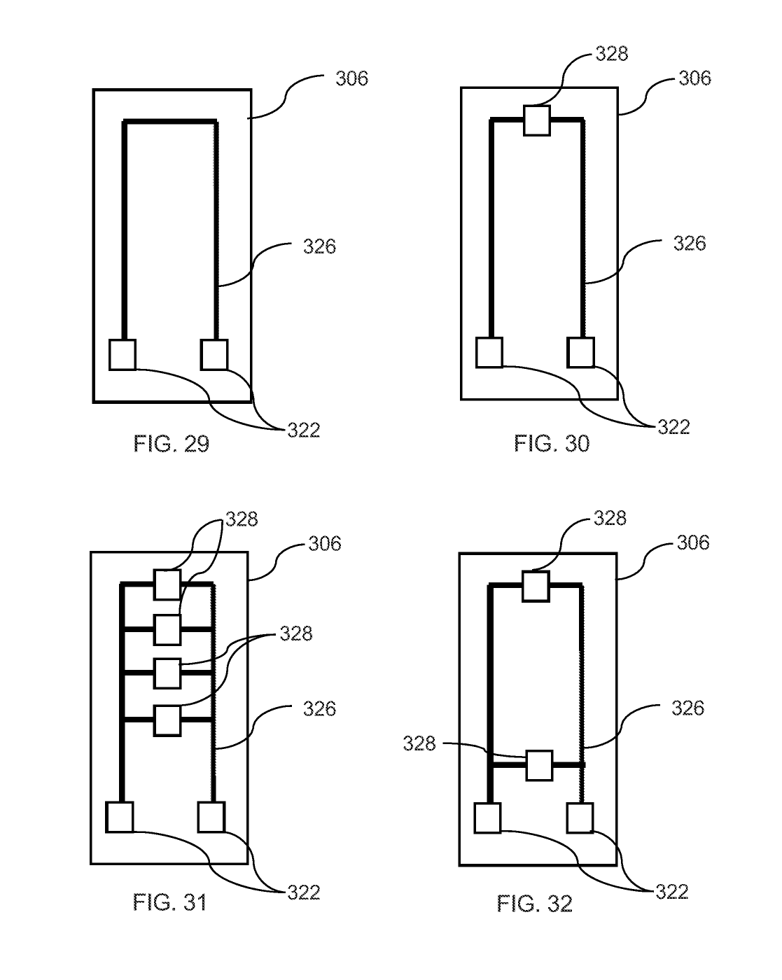

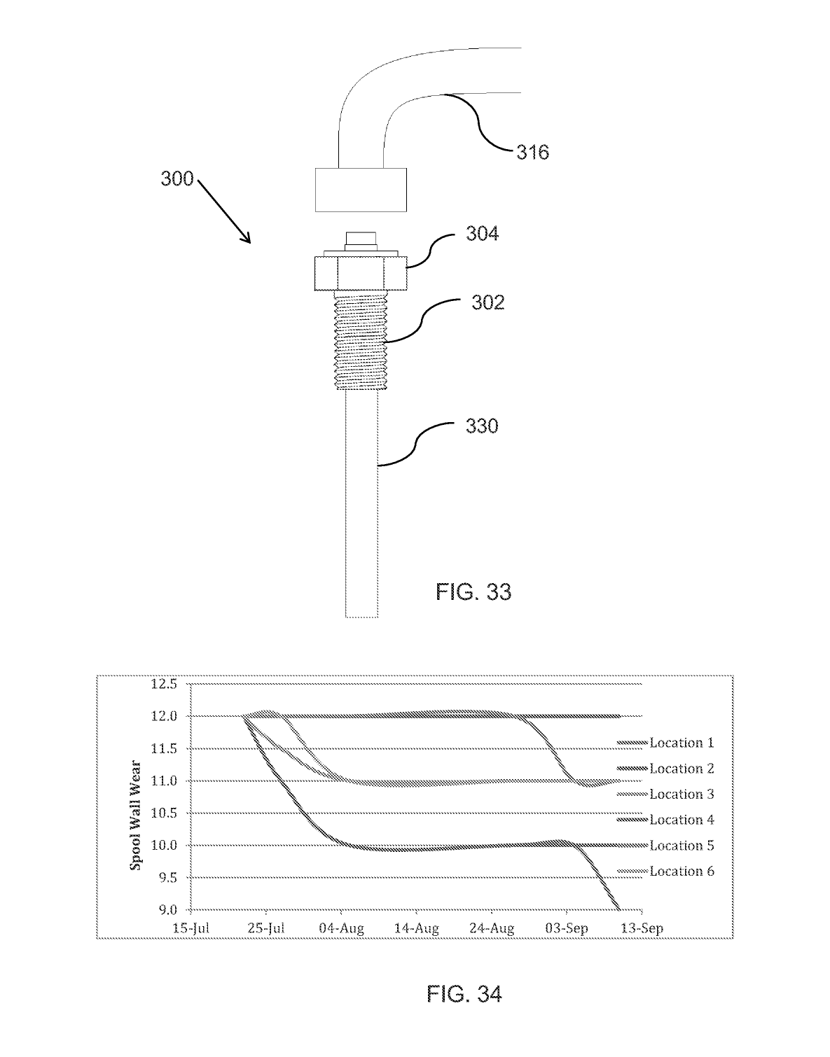

The installation in a pipe will now be described, although it will be understood that the procedure may be generalized to other materials as well. Referring to FIG. 25, a small hole 312 is made in the wall 314 of the pipe 310 to accommodate the WSD. Referring to FIGS. 26 and 27, the depth of the hole 312 is preferably the same as the length of the WSD shaft 302, but may be longer. In that case, the WSD 300 will only provide meaningful wear measurements once the wall 314 has been worn to certain degree. The WSD 300 is inserted into the hole 312 and attached using epoxy or other adhesive compound. Alternatively, the WSD 300 may be welded or spot welded into place. In a further alternative, the hole 312 may be threaded and the WSD 300 may be threaded into place. In another alternative, a “weld-o-let” (not shown) may be welded to the surface and the WSD may be inserted into the fitting and secured with epoxy or other adhesive compound or welded into place. In another alternative, a “thread-o-let” (not shown) may be welded to the surface and the WSD may be threaded into the fitting.

Referring to FIG. 25, the data collection or transmission device 315, such as the mote described above, may be mounted nearby the WSD 300 with wire connections 308 while FIG. 33 depicts the WSD 300 being connected by a cable 316. As discussed above, this device may include a processor for processing and interpreting the data, or may communicate the data to another processor. Alternatively, the WSD 300 may have processing capabilities and may output an appropriate reading. Alternatively, a processor (not shown) may be integrated into the WSD and there may be a wireless communications device to provide digital communication to the WSD.

FIG. 25 illustrates a side view of the WSD 300 installed in the wall 314 of the pipe 314. The depth of the WSD 300 corresponds to the material thickness at which the WSD will detect. In the illustration, wall 314 has an exterior surface 318 and an internal or wear surface 320. As surface 320 wears or losses material, the thickness decreases.

FIG. 26 illustrates the case where the wear surface 320 first exposes the WSD shaft 302. As the wear surface 320 continues to erode and WSD shaft 302 erodes. As the WSD shaft 302 erodes, the internal circuit board 306 (shown in FIG. 24) erodes. As the internal circuit board 306 erodes the resistance of the circuit changes. This change in resistance is detected by the data collection and transmission device 315.

In the example depicted in FIGS. 24 and 29-33, the WSD gauge circuit board 306 has two connection points 322 for connecting signal wires. There could be additional connection points for power wires or digital communication wires as well. A conductive trace 326 connects the attachment points 322 in FIG. 29. In FIG. 30, a resistive element 328 is attached near the distal end of the circuit board 306 and conductive traces 326 connect each end of the resistive element to the signal attachment points 322. In FIG. 31, there are multiple resistive elements 328 connected in parallel with each other and in series with the signal attachment points 322. Each resistive element 328 represents a unit of measure of wear. In FIG. 32, another resistive element 328 is attached close to the attachment points 322. This serves to act as a WSD self check to ensure integrity of the connection points 322 and wires connecting to the WSD 300.

The circuit board 306 or other sensing means may be formed inside the shaft 302 of the WSD, or, referring to FIG. 33, the sensing means may extend out below the shaft 302, in which case the portion that extends past shaft 302 may be referred to as a probe 330. Probe 330 may be made, and preferably moulded, from a variety of materials including polyurethane, rubber, neoprene or other mouldable material. In one example, the probe 330 may have an outer layer that encloses the inner mouldable material and stiffens the probe 330 to reduce or prevent sheer and torque strain on the moulded probe 330, such as when torque is applied to install the WSD 300. Reduction of sheer and torque strain on the sensor helps prevent damage to the WSD 300 during insertion and removal. The outer layer may be made of aluminium, stainless steel, carbon steel, fiberglass, urethane, rubber, carbon fibre or another material that is generally stiffer than the conformal material used to mould the probe. In yet another embodiment, the outer layer may be integrally formed with the sensor body. In addition, it will be understood that the sheath or outer later and the inner moulded section may be made from different material. For example, the upper section of probe 330 that is within shaft 302 may be made from a softer urethane that provides a better seal, while the lower portion of probe 330 may be made from a more durable urethane.

Referring to FIG. 21-23, in another embodiment, a WSD device 300 may include a strain sensor to measure the axial strain, fatigue or load. For example, WSD 300 may include a thickness sensor and a strain sensor. The depicted sensor 300 is threaded, such that it may be attached into a threaded socket, and may be used in place of other bolts as a connector. FIG. 21-23 WSD 300 has a wire connection 332 off to the side of head 304 rather than through the top.

Referring to FIG. 23, a hole 334 is machined down from the top to receive a sensor (not shown), and another hole 336 is machined in from the side while in FIG. 21, a groove 338 is machined into the head 304 of WSD 300. In each case, a connector (not shown) may be inserted into the hole 334/336 or groove 338 such that it connects with the sensor in the middle of the shaft 302, and extends outward to be flush with, or spaced from, the outer perimeter of the head 304 as well as the top surface. This allows connection to the sensor to be from the side face of the head 304 of the device 300 instead of the top. This has the benefit of not changing the vertical height of the WSD and therefore prevents interference with nearby moving or rotating equipment or debris. Moreover, the connector is embedded into the head and this provides a robust protection of the connector from moving or rotating equipment and debris. Furthermore, a mechanical tool, such as a wrench or socket, may be used to apply force to the device without interference from wires or a connector.

Alternatively, a connector may be fixed to the top. Alternatively, a wire may extend from the top or side of the device.

A data collection and/or transmission device may be a Wireless Sensor Device as described in PCT patent publication no. WO2012/058770.

### Pipeline Integrity Sensor

### Example 1

A pipeline integrity sensor was designed for monitoring the structural integrity of oil and slurry pipelines. In this example, the pipe wall thickness was monitored at critical locations. A Slurry Flow Loop (SFL) test facility was used for testing the pipeline integrity sensors.

Wear sensors were used for the pipe thickness measurement. The sensors were installed to critical locations on an 8″ diameter carbon steel test spool at the SFL. The data was collected using wireless sensing devices provided by Scanimetrics Inc. For assessment of the specific sensors results were compared using standard methods, such as ultrasonic thickness measurement and calipers to measure parameters for validation of the wireless sensor outputs.

An initial site survey was performed to verify cellular connectivity at the SFL. The installation of the pipeline integrity sensors included 6 wear sensors for the pipe thickness measurement, 8 stud tension sensors and 8 flange gap sensors for pipe flange integrity measurement. The wear sensors were installed with the NPT threaded outlets and proper sealing epoxy. Stud tension sensors were installed with proper torque wrench following standard tightening sequence up to the desired tension load, 120 ft lb. The pipe flange gap sensors were installed after the installation of the flanges with minimum initial stress in the sensors. The pipe flange sensors were attached t [symbol] rength epoxy.

Below is the summary of installation of the pipeline integrity sensors:

Installed six wear sensors at the middle section of an A105 carbon steel test spool with 0.5″ wall thickness. Six sensors were installed at every 60 degrees of the pipe section, i.e. 0, 2, 4, 6, 8, 10 o'clock for pipeline thickness measurement at these locations as shown below.

### Pipeline Integrity Sensor

### Example 2

Pipeline integrity sensors were designed for monitoring the structural integrity of oil and slurry pipelines. In this example the flange integrity was monitored at critical locations. A Pilot-Scale Slurry Flow Loop (SFL) facility was used for testing the pipeline integrity sensors.

Wear sensors were used for the pipe thickness measurement. The sensors were installed at critical locations on an 8″ diameter carbon steel test spool at the SFL facility. The data was collected using wireless sensing devices from Scanimetrics Inc. For assessment of the specific sensors, the results were compared using standard methods, such as digital torque gages and calipers, and ultrasonic tension measurement were used to manually measure parameters for validation of the wireless sensor outputs.

### Pilot Integrity Sensor

### Example 3

Pipeline integrity sensors were used for monitoring the structural integrity of oil and slurry pipelines. In this example, pipe wall thickness of a multi layer pipe was monitored, such as a Chromium Carbide Overlay pipe, Urethane Lined pipe, Rubber pipe and Rubber Lined pipe. In each case the sensor probe length was designed such that the distal end of the probe aligned with the wear surface at the time the sensor was installed.

Alternatively, the length of the probe could have been designed such that the distal end of the probe extended beyond the wear surface providing an way to calibrate the sensor for relative position due to insertion position errors, thread errors, etc. In another embodiment, the length of the probe could have been designed such that the distal end of the probe remained below the wear surface by 0.5 mm, 1.0 mm, 1.5 mm, 2.0 mm or more. Such a configuration would not actuate until the wear reached the distal end of the probe as described earlier.

The probe was designed to measure discrete wear steps of 0.25 mm, 0.5 mm, 0.75 mm, 1.0 mm, 1.5 mm, 2.0 mm. Other discrete wear steps could be used and they could be used in combination.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A seal integrity sensor device, comprising:
a force sensor integrally formed within an elastic compressible material, the elastic compressible material having a first surface and a second surface opposite the first surface, the force sensor generating a signal in response to a compressive force applied to the first and second surfaces, the signal being indicative of the compressive force.

2. The seal integrity sensor device of claim 1, wherein the signal is proportional to the displacement.

3. The seal integrity sensor device of claim 1, wherein the force sensor measures at least one of flange alignment, flange unloading, stud or bolt failure, gasket unloading, gasket creep, gasket disintegration and gasket failure.

4. The seal integrity sensor device of claim 1, wherein the seal integrity sensor further comprises a data collection device connected to receive data from the force sensor, the data collection device having a wireless communication module for communicating with a data network.

5. The seal integrity sensor device of claim 4, wherein the data collection device comprises an attachment for attaching to an object.

6. The seal integrity sensor device of claim 1, wherein the force sensor is sized to fit between flanges of a pipe connection.

7. A wireless seal integrity sensor device, comprising
a processor connected to a wireless transmitter;
at least one seal integrity sensor connected to provide signals to the processor, each seal integrity sensor comprising a force sensor integrally formed within an elastic compressible material, the elastic compressible material having a first surface and a second surface opposite the first surface, the force sensor generating a signal in response to a compressive force applied to the first and second surfaces, the signal being indicative of the compressive force;
a power source connected to power the processor and the wireless transmitter;
wherein the processor has two or more states and comprises at least one internal control element for sensing one or more predetermined conditions, the internal control element switching the processor between states based on the occurrence of at least one predetermined condition.

8. The wireless seal integrity sensor device of claim 7, further comprising a molded body that encloses at least the processor, the wireless transmitter, and the internal control sensor such that the internal control sensor is physically isolated within the molded body.

9. The wireless seal integrity sensor device of claim 8, wherein the molded body further encloses at least one of the power source and one or more sensors connected to the processor.

10. The wireless seal integrity sensor device of claim 8, wherein at least one sensor is external to the molded body and the processor is connected wirelessly to the at least one external sensor.

11. The wireless seal integrity sensor device of claim 8, wherein at least one sensor is external to the molded body and the processor is connected by a wired connection, where a portion of the wired connection is enclosed in the molded body.

12. The wireless seal integrity sensor device of claim 8, wherein the molded body enrobes at least the processor, the wireless transmitter, and the internal control sensor in a single piece construction.

13. The wireless seal integrity sensor device of claim 7, wherein at least one internal control element comprises one or more of:
an accelerometer, and at least one predetermined condition comprises detecting one or more predetermined accelerations;
an RF transponder, and at least one predetermined condition comprises introducing or removing an RF interrogator from its detection radius;
a magnetic sensor, and at least one predetermined condition comprises the introduction or removal of a magnetic element on an outer surface of the molded body.
a temperature sensor, and at least one predetermined condition comprises detecting a predetermined temperature; and
a gyro, and at least one predetermined condition comprises detecting a predetermined movement.

14. The wireless seal integrity sensor device of claim 7, wherein the at least one sensor measures at least one of flange alignment, flange unloading, stud or bolt failure, gasket unloading, gasket creep, gasket disintegration and gasket failure.

15. The wireless seal integrity sensor device of claim 7, wherein the processor comprises instructions to process sensor data from the sensing element according to an algorithm and transmit the processed data by the wireless transmitter.

16. The wireless seal integrity sensor device of claim 7, wherein the wireless transmitter comprises a wireless transceiver.

17. The wireless seal integrity sensor device of claim 7, wherein the processor is configured to operate as a node in a sensor network.

18. A method of operating a wireless seal integrity sensor device, the method comprising the steps of:
providing a wireless seal integrity sensor device, the wireless seal integrity sensor comprising:
a processor connected to a wireless transmitter;
at least one seal integrity sensor connected to provide signals to the processor, each seal integrity sensor comprising a force sensor integrally formed within an elastic compressible material, the elastic compressible material having a first surface and a second surface opposite the first surface, the force sensor generating a signal in response to a compressive force applied to the first and second surfaces, the signal being indicative of the compressive force; and
a power source connected to power the processor and the wireless transmitter;
installing the wireless seal integrity sensor at a location at which configuring the internal control element to switch the processor between states upon the occurrence of at least one predetermined condition; and
applying at least one predetermined condition to the internal control element.

19. The method of claim 18, wherein the force sensor is installed between pipes ends in a pipe connection.

20. The method of claim 18, wherein the force sensor is installed by inserting the force sensor between two components in a connection.
